(19) United States
(12) Patent Application Publication
(10) Pub. No.: US 2002/0025286 A1
(43) Pub. Date: Feb. 28, 2002

(54) System, method and product-by-process for treatment of exhaust gases

(76) Inventors: Rodrick J. Gravley, Albany, OR (US); McRea Willmert, Wilsonville, OR (US)

Correspondence Address: Charles E. Gotlieb, Innovation Partners, Suite 300, 540 University Avenue, Palo Alto, CA, 94301, US

(21) Appl. No.: 09/942,788

(22) Filed: Aug. 29, 2001

Related U.S. Application Data
(60) Provisional application No. 60/229,252, filed on Aug. 30, 2000.

(51) Int. Cl. B01D 53/68

(52) U.S. Cl. 423/240 R; 423/241; 423/489; 422/186.04

(57) ABSTRACT

A system and method processed gases from an exhaust stream using by pulsing energy through a corona wire near the exhaust stream and adding a reagent gas to combine with the exhaust when the exhaust and reagent gas receives the energy.

### BACKGROUND OF THE INVENTION

Certain manufacturing processes exhaust gases. Gases exhausted by semiconductor manufacturing processes can include some or all of nitrogen, process gases introduced to the process, including silane, ammonia and oxygen, byproducts of the process, including particulates, and Fluorine or PFCs used for cleaning and other purposes.

Some gases are removed from exhausts of manufacturing processes for environmental, worker health and safety, or other reasons. For example, PFCs in exhaust gases that are produced as a result of cleaning certain semiconductor manufacturing equipment are removed from the exhaust stream using conventional point of use scrubbing equipment prior to releasing the exhaust into the atmosphere. Conventional point of use scrubbing equipment may include thermal treatment, water scrubbing or chemical absorption equipment.

Gases containing fluorine, such as nitrogen trifluoride (NF₃) can clean the same semiconductor manufacturing equipment better than PFCs. The NF₃ gas is converted to F₂ during the cleaning process and the F₂ must then be removed from the exhaust of the semiconductor manufacturing facility. F₂ is not easily scrubbed from exhaust gas, so current methods of removal include mixing the exhaust gas with a source of hydrogen, heating the resulting mixture to a high temperature to allow the hydrogen to combine with the fluoride to produce hydrogen fluoride (HF) and then running the heated HF through a water wash scrubber to remove and cool the hydrogen fluoride.

There are several problems with this approach. First, a large amount of energy is required to heat the F₂ to cause it to combine with the hydrogen because much of the energy is absorbed by a nitrogen carrier gas and the surrounding metal enclosure in which the F₂ is heated. These energy costs increase the costs of removal of the F₂. While it is possible to concentrate the heat energy using conventional methods such as narrow openings, if there are particulates in the exhaust stream, they tend to clog the narrow openings resulting in increased maintenance of the openings and shut down of the pumps due to clogging of the abatement devices. When the pumps shut down, the processing steps generating the exhaust being controlled by the pump may also be shut down. Because many process steps, if terminated prematurely, damage the material being processed, pump shut down leads to significant waste. Additionally, some process steps require calibration or qualification of tools being restarted. When the pumps are restarted, the time required for calibration or qualification can cause additional downtime, reducing the output of the manufacturing facility, This causes the manufacturing facility to spread its overhead across a smaller number of products and pay for operators and maintenance workers who may sit idle, raising the costs for each product produced.

Second, the high heat of the abatement process requires additional time to maintain the abatement equipment as workers wait for the equipment to cool down prior to maintaining it and wait for temperatures to rise to normal operating temperatures before it may be used again, increasing maintenance costs for the equipment. Because use of the processing equipment that generates the F₂ may need to be suspended while the abatement equipment is being maintained, output of the facility is reduced. This causes the manufacturing facility to spread its overhead across a smaller number of products and pay for operators who will sit idle, raising the costs for each product produced.

Third, because the abatement equipment is located in the manufacturing facility itself, the space required for the abatement equipment further drives up the costs of operation. The high heating of the conventional abatement equipment requires insulation, making the abatement equipment relatively bulky in an environment in which space costs can run in excess of $3000 per square foot. In addition, as the manufacturing facility is reconfigured, the relatively bulky abatement equipment can restrict the location of the processing equipment producing the gas requiring abatement to a location with sufficient space to handle the abatement equipment.

Fourth, scrubbing F₂ gas in a manufacturing facility can require a large number of scrubbers, each with a large number of parts, leading to high maintenance costs. The large number of scrubbers may be required to allow the scrubbers to remain as close to each tool that uses the NF₃ as possible, for several reasons. Because F₂ can be harmful to workers exposed to it, it is desirable to abate the F₂ as close to the tool as possible to reduce the potential for an escape of the gas containing it. It is also desirable to abate the F₂ as close to the tool as possible because F₂ emits a foul odor in small quantities, so escape of very small amounts is detectable by the workers operating the manufacturing processes. The farther the abatement equipment is from the source of F₂, the more F₂ will escape from the plumbing used to contain it.

While it is theoretically possible to alleviate these problems by converting the F₂ to HF and then piping the HF to a central scrubber, it is desirable to keep the scrubber as near to the tool as possible to reduce plumbing requirements that would be required to transport the exhaust from multiple tools into a smaller number of scrubbers. HF is corrosive and presents materials incompatibility issues with many systems that may already be in place to handle exhausts, so separate plumbing required for collection. Not only does the plumbing take up space in the facility, it tends to be expensive. Because the HF generated is so hot, inexpensive plastics could not be used, nor could metals be used due to the corrosive nature of HF.

Thus, to abate the fluorine from many areas of the manufacturing facility, the abatement equipment must be kept close to the each source of F₂. If there are many sources of F₂, many scrubbers are required. Because of the many scrubbers and the many parts in each scrubber, the maintenance of the scrubbers increases the costs for the manufacturing facility.

In addition to the costs of maintenance for the scrubbers, when the scrubbers are down for maintenance, the tools that generate the exhaust being scrubbed may be shut down as well. This causes the manufacturing facility to spread its overhead across a smaller number of products and pay for operators who will sit idle, raising the costs for each product produced.

Fifth, the large volume of water used by the scrubbing process may need to be treated, although the concentration of fluorine in the water is relatively low. The F₂ gas may be generated by some tools intermittently and only for a fraction of the total time the plant is in operation, although the scrubbers operate continuously, causing water to flow through them and on to the treatment facility, producing a relatively large volume of water relative to the amount of fluorine scrubbed. In addition, each scrubber may need to be larger than required to scrub the amount of fluorine due to the physics of the scrubbing process, increasing the consumption of water beyond that necessary to scrub the fluorine, yet all of the water may then need to be treated. In many circumstances, treatment facilities must be on hand to process the large volumes of water only to remove a relatively small amount of fluorine. As the size of the treatment facility exceeds certain thresholds, government permits may be required to allow the treatment facility to be built and operated. In addition, an exhaust system must be used to ventilate the scrubbers. All of these issues (water used, size of treatment facilities, permit times and expenses, and exhaust system) increase the costs of operating the manufacturing process.

Silane is another gas that may be exhausted by semiconductor processing equipment and by other equipment. Silane is highly reactive and therefore, it must be abated as close to the tool producing it as possible to prevent explosions in the manufacturing facility. If the equipment that abates fluorine does not also abate silane, the equipment to abate silane can take up additional space in the manufacturing facility, and require additional energy and maintenance.

What is needed is a system and method for processing fluorine that is more energy efficient, is not fouled by particulates, doesn't take as long to maintain, has fewer parts to maintain, occupies less space, does not require large amounts of water or a large treatment facility, and can optionally abate silane.

### SUMMARY OF INVENTION

A system and method receives an exhaust that includes fluorine and at least one reagent gas and applies pulses of energy to the exhaust and reagent gas received to cause the reagent gas and exhaust to interact. The reagent gas may include hydrogen, which is capable of interacting with the fluorine in the exhaust when the energy is applied. If the exhaust includes oxidizables, such as silane (SiH₄) and phosphine, the at least one reagent gas may include oxygen to interact with these other elements in the exhaust. The pulses of energy may be applied using a corona wire near the gas and exhaust. The output stream may be slowed so that particulates may be collected and optionally, swept away using a mechanical device such as an auger. The output of multiple systems may be collected and scrubbed. A method and apparatus also applies energy in any form to the exhaust and the reagent gas and supplies the result to a water wash at not more than approximately 40 degrees Celsius.

### BRIEF DESCRIPTION OF THE DRAWINGS

FIG. 1 is a block schematic diagram of a system for processing at least one gas containing fluorine according to one embodiment of the present invention.

FIG. 2 is a block schematic diagram of a reactor of FIG. 1 according to one embodiment of the present invention.

FIG. 3 is a flowchart illustrating a method of processing at least one gas containing fluorine according to one embodiment of the present invention.

FIG. 4 is a block schematic diagram of a system for processing at least one gas containing fluorine from two tools using a single scrubber according to one embodiment of the present invention.

### DETAILED DESCRIPTION OF A PREFERRED EMBODIMENT

Referring now to FIG. 1, a system 100 for removing Fluorine from exhaust gases is shown according to one embodiment of the present invention. The system 100 includes a conventional pulse corona reactor 108, such as the conventional Pulse Corona Reactor, Model N, commercially available from Maxwell Technologies Systems Division, Inc., of San Diego, Calif., modified as described herein. Portions of that reactor are described in part in international application Serial Number WO 99/25471 filed May 27, 1999 by Maxwell Technologies Systems Division, Inc. entitled “Pulsed Corona Discharge Apparatus with Radial Design” and published by the World Intellectual Property Organization and in U.S. Pat. No. 5,490,973 entitled, “Pulsed Corona Reactor System for Abatement of Pollution by Hazardous Agents” by Grothaus, et al. issued, Feb. 13, 1996 and those applications are hereby incorporated by reference in their entirety.

A conventional pulse corona reactor 108 contains a power supply 110 with a power input 111 that is connected to a power source such as a 240 VAC supply line. Power supply 110 rectifies the supply voltage at input 111 and may step up the voltage through the use of one or more transformers. The rectified voltage is a DC voltage that may be stored in energy storage 112 which is made of one or more capacitors or other devices that can store and rapidly fully or partially discharge the energy supplied by power supply 110 when a circuit is closed by energy discharge 114. In one embodiment, energy storage 112 stores 20 KV from a 600 amp power supply 110.

Energy discharge 114 is any device that can complete a circuit when the voltage from energy storage reaches or exceeds a threshold. In one embodiment, energy discharge 114 is a conventional spark gap switch. The spark gap switch may be similar to that described in U.S. Pat. No. 6,037,715 issued to Hammon et al on Mar. 14, 2000 or may be any other type of switch. A spark gap switch completes a circuit by allowing the energy to arc across a gap between two electrodes when the energy reaches a sufficient voltage to produce the arc across the gap. When this occurs, the energy is provided to reactor 150, and the energy briefly energizes reactor 150, which receives exhaust gases and other gases from inlet manifold 120. In one embodiment, energy discharge 114 discharges energy storage 112 at a rate of 100 pulses per second, with an approximate 18 ns pulse of 20 megawatts.

Inlet manifold 120 receives and mixes gases and provides the mixed gases to reactor 150. Exhaust gases containing fluorine are received from vacuum pumps 130, 132, which receive the exhaust gases from tools coupled to inlets 121, 133.

A conventional pulse corona reactor 108 receives the exhaust gases containing elements to be processed and processes them alone. However, according to the present invention, reagent gases are introduced into inlet manifold 120 to be mixed with the exhaust gases containing the fluorine to be reacted in the reactor 108. These reagent gases may include hydrogen gas H₂ from a hydrogen source, H₂ supply 134 and oxygen, such as available clean dry air from a filtered source, CDA supply 136, although any source of oxygen may be used. Flow rates of each of the H2 supply 134 and CDA supply 136 are approximately 4-5 liters per minute to handle exhaust flow rates of 20-50 liters per minute from each of up to four inlets 121 (although only two exhaust sources 130, 132 are shown in the figure, any number may be used).

Controller 140 operates the H₂ supply 134 and CDA supply 136 and the power supply 110 to the pulse corona reactor 108 to allow the H₂ supply 134 and CDA supply 136 and the power supply 110 to operate together and shut off together.

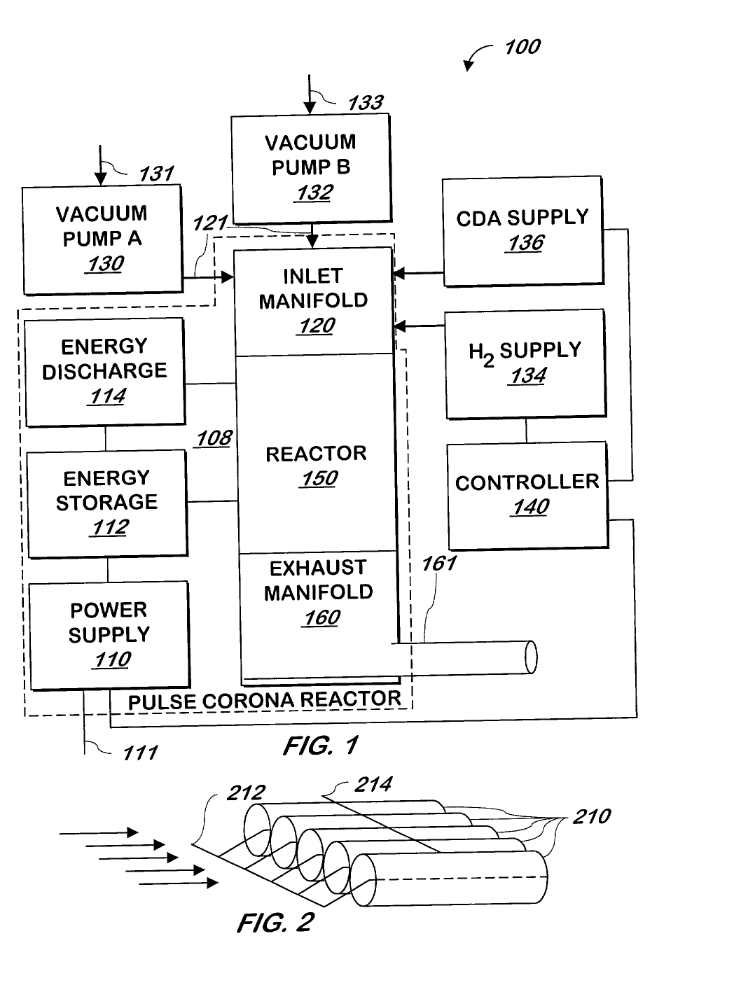

The operation of reactor 150 is illustrated in FIG. 2. Referring now to FIGS. 1 and 2, the reactor 150 contains conduits 210 made from a conducting material electrically coupled together using conductor 214 and a corona wire 212, also made of a conducting material, running lengthwise through each of the conduits and coupled together. In one embodiment, the conduits are tubes having a one inch diameter and there are ten tubes in parallel with one another. The conducting material of the corona wire may be the same or different as that of the conduits 210. In one embodiment, the conducting material of the corona wires 212 and the conduits 210 is stainless steel to prevent corrosion from the exhaust gases, which run through each of the conduits 210 in the direction of the arrows on the Figure. When the reactor is energized, the electricity arcs from the corona wires 212 to the conduits 210 and imparts energy to the gases flowing through the conduits 210 from the inlet manifold 120. The energy helps cause reactions to occur in the conduits 210. The reactions include the conversion of H₂ and F₂ into components including HF, and may include the conversion of other gases that may be present in the manufacturing process, such as phosphine PH₃ and silane, into other components that are easier to scrub though a conventional water wash system.

Exhaust manifold 160 has a cross sectional area greater than the combined cross sectional area of the conduits 210 of reactor 150 so as to reduce the speed of the gas flowing through it, allowing the silane, that has been combined in the reactor 150 with the oxygen to become silica dioxide, a solid, and other particulates to fall to the bottom of the manifold 160 where an opening in the upstream side of outlet 161 collects it. The particulates may then be easily removed. In one embodiment, outlet 161 contains a conventional manual or automatic auger (e.g. an electric auger), that removes the particulates from outlet 161 using a screw motion.

In addition to the changes described above, inlet 121 and exhaust 161 port sizes may be made sufficiently large to accommodate particulates, the inlet manifold 120, reactor 150 and exhaust manifold 160 may be allowed to be disassembled for maintenance, and they may be made sufficiently light for ease of handling during maintenance. In one embodiment, exhaust port 161 is an eight inch diameter pipe that is eight inches in length, (The exhaust port is shown in more detail in the Figure than other ports.) Inlet 121 includes four pipe inlets, each having a two inch diameter. The weight is kept low by eliminating any unnecessary metal from the reactor 150 and manifolds 120, 160.

The reactor 150 tends to heat the mixture of exhaust and gases up to the range of 30, 40 or 50 degrees Celsius at the exhaust port 161 of the system. The HF that results remains a gas as in conventional systems, but the HF is not hot. Thus, the HF that results from many or all of the tools in a facility may be processed using multiple pulse corona reactors 108 with all of their outputs piped together as shown in FIG. 4 with two tools 410, two systems 100 of FIG. 2 that are on the order of a few inches or a few feet from each tool 410, and a scrubber 412 that collects the output of each of the systems 100 and is more than a few feet from each tool. Although two tools 410 and two systems are shown in the figure as feeding a single scrubber 412, any number of tools 410 may feed any number of systems 100 which may feed any number of scrubbers 412. Tools 410 may include conventional epitaxy tools, implant tools, dry etch tools, chemical vapor deposition tools, diffusion tools and metals tools, although other tools may be used.

The discharge from all of these systems 100 may be efficiently scrubbed using fewer scrubbers (as few as one for many tools) than the conventional approach described above in which many scrubbers are used, and as a result, the system uses fewer scrubbers to scrub the same amount of HF. If the scrubbers are water wash systems, less water may be used than is used by conventional water wash systems. The water used to scrub the HF may then be treated using a far smaller facility than conventional approaches and the maintenance of the scrubbers is reduced. Maintenance of the abatement equipment can be performed faster than conventional abatement systems because the reactor does not get as hot as the abatement equipment in conventional systems.

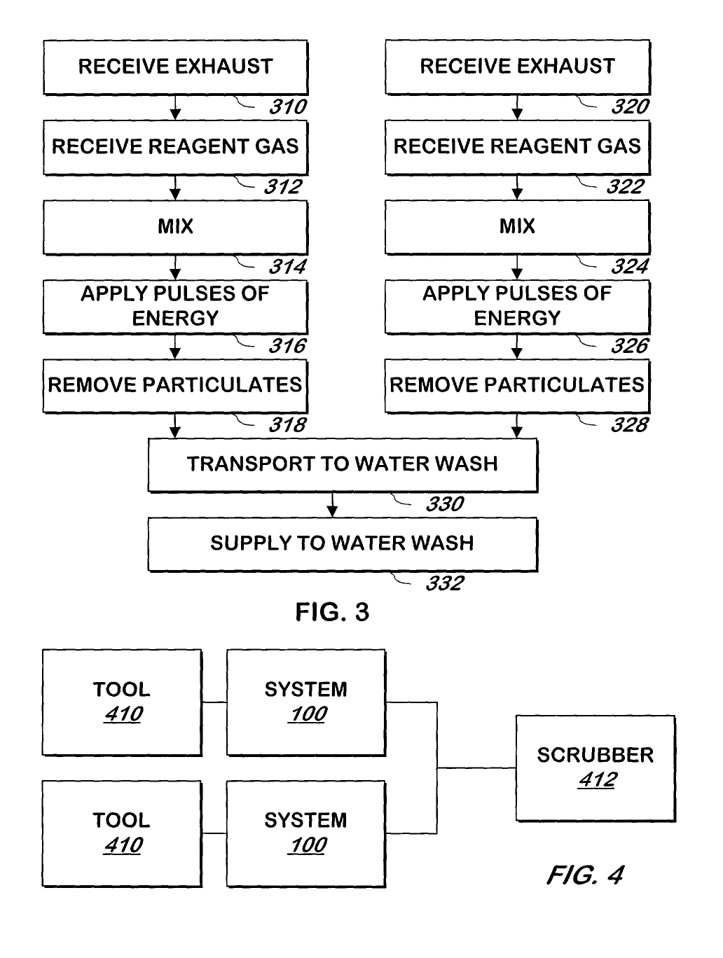

Referring now to FIG. 3, a method of processing exhaust is shown according to one embodiment of the present invention. The exhaust is received 310 as described above. The exhaust may contain fluorine, and may optionally contain phosphine, silane or both as described above. A reagent gas, including the components described above, to react with the exhaust is received 312 as described above. The reagent gas received in step 312 is mixed 314 with the exhaust received in step 310 and pulses of energy are applied 316 to ionize the exhaust and cause it to react with the gas as described above. As described above, the application of pulses of energy may be made by inserting the gas and exhaust into a chamber with a corona wire and applying the pulses of energy using the corona wire and chamber as conductors. In one embodiment, steps 312 and 316 are operated in conjunction with each other so that the pulses of energy are applied when the gas is received.

The speed of the resulting output stream is reduced 318 to allow particulates to fall and the particulates may be collected and removed, for example by an auger.

In one embodiment, steps 310 through 318 are duplicated in steps 320 through 328, respectively to process the exhaust of a different process or a different machine or the same machine from the same process having the exhaust processed in steps 310 through 318.

The output from either or both sets of steps, 310 through 318, and 320 through 328, are transported to a location 330 and washed 332. The output supplied to the water wash in step 332 may be supplied at a temperature of less than approximately 30, 40 or 50 degrees Celsius.

Although the figure illustrates the output from two sets of steps being transported and collected, the output from one, or any number greater than one, set of steps may be collected and washed together. The transporting step 330 from each set of steps may be performed independently for each set of steps, or the outputs from each set of steps may be mixed together for transport. Water washing 332 may be performed by a single water wash unit, multiple units or multiple individual streams of output washed by a single or multiple water wash units.

Any product may be produced in a production process that uses the above method. Such products include microelectronics and flat panel displays.

What is claimed is:

1. A method of processing exhaust, comprising:
receiving the exhaust;
receiving a reagent gas capable of reacting with at least a portion of the exhaust;
applying pulses of energy to the exhaust received and the reagent gas received, so as to cause at least a portion of the fluorine in the exhaust to interact with at least a portion of the reagent gas received.

2. The method of claim 1 wherein:
the exhaust comprises fluorine; and
the reagent gas comprises hydrogen.

3. The method of claim 1, wherein:
the exhaust comprises an oxidizable element; and
the reagent gas comprises oxygen.

4. The method of claim 1 wherein the applying step is performed using at least one corona wire.

5. The method of claim 1 additionally comprising the step of mixing the exhaust with the reagent gas.

6. The method of claim 1, additionally comprising removing particulates from the reagent gas and exhaust to which the pulses have been applied.

7. The method of claim 6 wherein the removing step comprises:
collecting the particulates; and
applying an auger to the particulates.

8. A method of processing an exhaust, the method comprising:
receiving the exhaust;
receiving a gas capable of reacting with the exhaust;
applying energy to the exhaust and the gas;
supplying at least a portion of the exhaust and at least a portion of the gas at a temperature of less than approximately 40 degrees Celsius to a water wash; and
water washing the at least the portion of the exhaust and the at least the portion of the gas.

9. A product made using the method of claim 1.

10. A product made using the method of claim 2.

11. A product made using the method of claim 3.

12. A product made using the method of claim 4.

13. A product made using the method of claim 5.

14. A product made using the method of claim 6.

15. A product made using the method of claim 7.

16. A product made using the method of claim 8.

17. A system for processing exhaust, comprising:
a manifold having at least one first inlet operatively coupled for receiving the exhaust and at least one second inlet operatively coupled for receiving at least one gas capable of reacting with at least a portion of the exhaust, the manifold for mixing the exhaust with the at least one gas to produce a mixture, and for providing the mixture at an outlet; and
a reactor having an inlet coupled to the manifold outlet for receiving the mixture, and having an input for receiving a plurality of pulses of energy per second, the reactor for applying to the mixture at least a portion of the plurality of pulses of energy received to produce and provide at an outlet a reacted mixture.

18. The system of claim 17 wherein:
the exhaust comprises fluorine; and
the at least one gas comprises hydrogen.

19. The system of claim 17 wherein the exhaust comprises an oxidizable element and the at least one gas comprises oxygen

20. The method of claim 17 wherein the reactor comprises at least one corona wire coupled to the input, the corona wire for applying to the mixture at least a portion of the plurality of pulses of energy received.

21. The system of claim 17 additionally comprising an auger coupled to the reactor outlet, the auger for removing particles from the reacted mixture.

22. A system for processing exhaust, comprising:
a manifold having at least one first inlet operatively coupled for receiving the exhaust comprising fluorine and at least one second inlet operatively coupled for receiving at least one gas capable of reacting with at least a portion of the fluorine in the exhaust, the manifold for mixing the exhaust with the at least one gas to produce a mixture, and for providing the mixture at an outlet; and
a reactor having an inlet coupled to the manifold outlet for receiving the mixture, and having an input for receiving energy, the reactor for applying to the mixture at least a portion of the energy received to produce and provide at an outlet a reacted mixture at a temperature less than approximately 40 degrees Celsius.

23. A method of processing a first exhaust gas comprising fluorine produced by a first apparatus at a first location and a second exhaust gas comprising fluorine produced by a second apparatus at a second location, the method comprising:
processing the first exhaust gas near the first location to produce a first output;
processing the second exhaust gas near the second location to produce a second output;
transporting the first output and second output to a third location; and
scrubbing the first output and the second output using a single water wash at the third location.

24. A system for processing a first exhaust gas comprising fluorine produced by a first apparatus at a first location and a second exhaust gas comprising fluorine produced by a second apparatus at a second location, the method comprising:
a first gas processor near the first location having an input operatively coupled for receiving the first exhaust gas, the first gas processor for reacting the first exhaust gas with a first reagent gas received at a reagent gas input of the first gas processor to produce a first processed exhaust provided at a first gas processor output;
a second gas processor near the second location having an input operatively coupled for receiving the second exhaust gas, the second gas processor for reacting the second exhaust gas with a second reagent gas received at a reagent gas input of the second gas processor to produce a second processed exhaust provided at a second gas processor output; and
a scrubber at a third location having a first input coupled to the first gas processor output and a second input coupled to the second gas processor output, the scrubber for removing and providing at a scrubber output at least a portion of the first processed exhaust received at the scrubber first input and at least a portion of the second processed exhaust received at the scrubber second input.
